(19) United States
(12) Patent Application Publication
(10) Pub. No.: US 2003/0152826 A1
(43) Pub. Date: Aug. 14, 2003

(54) Electronic device

(76) Inventor: Shuichi Matsuzawa, Tokyo (JP)

Correspondence Address: MORGAN & FINNEGAN, L.L.P., 345 PARK AVENUE, NEW YORK, NY, 10154, US

(21) Appl. No.: 10/366,001

(22) Filed: Feb. 13, 2003

(30) Foreign Application Priority Data
Feb. 14, 2002 (JP) 2002-036849
Feb. 18, 2002 (JP) 2002-040078

(51) Int. Cl. H01M 2/10

(52) U.S. Cl. 429/100; 429/123; 429/98; 429/97; 429/99

(57) ABSTRACT

An electronic device includes a battery lid (9) which is openably/closeably formed at an opening of a battery housing chamber where a battery (6) is to be loaded removably and which has an engaging portion, at its position where the battery lid closes the opening, for keeping the opening closed, and an electrode plate (8) formed of a conductive member held by the battery lid (9) so as to be in contact with an electrode of the battery (6) when the battery lid (9) is in the closed state, wherein the electrode plate (8) has a contact portion (8a) extending integrally from its base which is held by the battery lid (9) so as to come into contact with the electrode of the battery (9), and is made of an elastic body that resists a pressing force applied by the electrode of the battery (6) when the battery lid (9) is closed with the battery (6) being housed in the battery housing chamber.

### FIELD OF THE INVENTION

The present invention relates to an electronic device such as an electronic image sensing device which operates with a rechargeable battery as a power supply and electronically records an object image sensed by an image sensing element on a recording medium or the like and, more particularly, to an improvement of lid members that cover the openings of a battery housing chamber and recording medium housing chamber.

### BACKGROUND OF THE INVENTION

Conventionally, an electronic device such as an electronic image sensing device has, at the opening of a battery housing chamber where a plurality of batteries or rechargeable batteries can be loaded, a battery lid which can be opened and closed and which has a locking mechanism at its closed position. Electrode pieces are arranged on the inner surface of the battery lid and on the deep side in the battery housing chamber. In particular, the electrode pieces on the deep side in the battery housing chamber have leaf- or coil-like shapes with a spring pressure/spring force (elastic force). When a vibration acts on the battery housing chamber, connection of the batteries and electrode pieces is maintained by the elastic force of the electrode pieces.

An electrode at one end of each battery is pressed by the battery contact piece having a spring pressure/spring force, and the battery is urged against the stationary contact piece at the other end, thus achieving electrical connection. If the photographer erroneously applies an excessive impact to the electronic device such as an image sensing device, the battery loaded in the electronic device vibrates by the applied impact against the spring pressure/spring force of the battery contact piece, and so-called “battery floating” may occur or the battery may undesirably separate from the stationary contact piece. This disconnects electrical connection temporarily. Power is not correctly supplied to an electric circuit that controls the device, causing erroneous operation.

As a technique that ensures electrical connection with the battery electrode, a technique disclosed in, e.g., Japanese Patent Laid-Open Nos. 11-72831 and 11-26596, is known.

The above references disclose the following technique. An elastic electrode member and non-elastic electrode member are arranged on the inner surface of a battery lid. The elastic electrode member can be set in a state where it can be in contact with the battery electrode together with the non-elastic electrode member, and a state where, when it separates from the non-elastic electrode member due to an impact or the like, the elastic electrode member elastically deforms to follow the battery so that it maintains contact with the battery electrode.

In the device proposed in the above references, a plurality of electrode members are used, and they are fixed to the battery lid with machine screws. This increases the number of components and degrades the assembling workability, leading to an increase in cost.

If the spring pressure of the electrode piece of the electrode plate and that of the electrode piece arranged on the deep side in the battery housing chamber are equal, when an excessive impact or the like is applied, the spring pressure of that electrode around which the surrounding structure has a higher rigidity is not absorbed by the surrounding structure, and this electrode piece tends to lose its spring properties.

The larger the difference in spring pressure between the two electrodes, the more apparent this phenomenon. In this structure, a small elastic electrode member (coil spring or the like) is arranged in the non-elastic electrode member on the inner surface of the battery lid. With this structure, it is difficult to form an elastic electrode member having a strength that can resist the spring pressure of the electrode piece arranged on the deep side in the battery chamber.

As the electrode changes from the non-elastic electrode member to the elastic electrode member, the voltage (contact resistance) changes, adversely affecting the service life of the power supply.

The electronic device such as the conventional electronic image sensing device has, in addition to the battery housing chamber where a plurality of batteries are to be loaded, a recording medium housing chamber where a recording medium for recording various types of information (object image and the like) is to be loaded. The openings of the battery housing chamber and recording medium housing chamber respectively have lid members which can be opened and closed and which have locking mechanisms at their closing positions. The lid members are arranged on different surfaces (positions) of the electronic device main body. For example, in some example, the battery lid is formed on the bottom surface of the electronic device, while the recording medium lid is formed on the side surface of the electronic device main body.

In the electronic device such as the electronic image sensing device in the above prior art, if the battery lid and recording medium lid are formed at different surfaces (positions), their pivot shafts must be arranged at different portions, and the number of components increases.

As a technique for solving the above problem, Japanese Patent Laid-Open No. 11-17991 describes the following technique. A recording medium pivotal lid for a recording medium housing chamber is formed on the side surface of the holding portion of the main body of an electronic device such as an electronic image sensing device, and a battery pivotal lid for a battery housing chamber is formed on the rear surface of the holding portion. The recording medium pivotal lid and the battery pivotal lid share a rotating shaft. Also, a technique is generally known in which a lid member to be shared by a recording medium housing chamber and battery housing chamber is formed on the bottom surface of an electronic device main body.

In the technique proposed by the above reference, the recording medium pivotal lid for the recording medium housing chamber is formed on the side surface of the holding portion of the main body of the electronic device, and the battery pivotal lid for the battery housing chamber is formed on the rear surface of the holding portion. The recording medium pivotal lid and the battery pivotal lid share the rotating shaft. Although the rotating shaft is shared by the pivotal lids, the lid members are arranged at different surfaces (positions). Therefore, to form the lid members on the side surface and rear surface, respectively, of the holding portion, an outer appearance space is required. Also, locking mechanisms for holding the lid members must be separately formed. This leads to problems such as an increase in apparatus size.

Furthermore, in the technique in which the lid member to be shared by the recording medium housing chamber and battery housing chamber is formed on the bottom surface of the electronic device main body, when changing the recording medium, the battery may be ejected due to the elastic force of the battery contact piece on the deep side in the battery housing chamber. This interferes with the changing operation, and the battery may drop. Thus, this technique has poor operability.

### SUMMARY OF THE INVENTION

The present invention has been made in view of the above situation, and has as its first object to provide an electronic device in which disconnection/incomplete contact, which is caused by an impact or the like, of a battery electrode and an electrode piece that should be in contact with it is prevented, and reduction in number of components, improvement in assembling easiness, cost reduction, and the like can be realized.

It is the second object of the present invention to provide an electronic device in which an outer appearance space necessary for lid members that can open and close a battery housing chamber for housing a battery and a recording medium housing chamber for housing a recording medium is minimized to achieve down sizing, and the number of components can be reduced and the operability during recording medium change or the like can be improved without impairing the function the electronic device originally has.

In order to achieve the first object, an electronic device according to the present invention comprises a battery lid which is openably/closeably formed at an opening of a battery housing chamber where a battery is to be loaded removably and which has an engaging portion formed at its position where the battery lid closes the opening, the engaging portion being adapted to keep the opening closed, and an electrode plate formed of a conductive member held by the battery lid so as to be in contact with an electrode of the battery when the battery lid is in the closed state, wherein the electrode plate has a contact portion extending integrally from a base thereof which is held by the battery lid so as to come into contact with the electrode of the battery, and is made of an elastic body that resists a pressing force applied by the electrode of the battery when the battery lid is closed with the battery being housed in the battery housing chamber.

In order to achieve the second object, an apparatus according to the present invention comprises a recording medium housing chamber for housing a recording medium; a battery housing chamber for housing a battery; a first lid for opening/closing the recording medium housing chamber; and a second lid for opening/closing the battery housing chamber, the second lid being formed inside the first lid.

Other objects and advantages besides those discussed above shall be apparent to those skilled in the art from the description of a preferred embodiment of the invention which follows. In the description, reference is made to accompanying drawings, which form a part thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a perspective view of an electronic image sensing device as an example of an electronic device according to the present invention, in which a battery lid is open;

FIG. 2 includes a partially cutaway front view of the electronic image sensing device as an example of the electronic device according to the present invention, and a view showing an arrangement inside the battery lid of the same;

FIG. 3 includes a partially cutaway front view showing other examples of an electrode plate and battery contact portions in the electronic image sensing device as an example of the electronic device according to the present invention, and a view showing an arrangement inside the battery lid of the same;

FIG. 4 is an enlarged perspective view showing in detail an assembly example of a battery lid and electrode plate for the electronic image sensing device as an example of the electronic device according to the present invention;

FIG. 5 is a perspective view showing in detail an arrangement of an electronic image sensing device as an example of the electronic device according to the present invention with the battery lid being open, in which spring shape portions are added for aiding the battery lid to open;

FIG. 6 is a partially cutaway front view showing the outer appearance and inner arrangement of an electronic image sensing device as an example of the electronic device according to the present invention;

FIG. 7 is a perspective view of the electronic image sensing device as an example of the electronic device according to the present invention, in which a memory medium lid serving as the outer lid is open and a battery lid serving as the inner lid is closed;

FIG. 8 is a perspective view of the electronic image sensing device as an example of the electronic device according to the present invention, in which the memory medium lid serving as the outer lid and the battery lid serving as the inner lid are both open; and

FIG. 9 is a side view of the electronic image sensing device as an example of the electronic device according to the present invention, in which the memory medium lid serving as the outer lid is open, the battery lid is closed, and a strap is attached.

### DETAILED DESCRIPTION OF THE PREFERRED EMBODIMENTS

The embodiment of the present invention will be described in detail with reference to the accompanying drawings.

The embodiments to be described below show examples of means that realize the present invention. The present invention can be applied to those obtained by changing or modifying the following embodiments without departing from the spirit of the invention.

[First Embodiment]

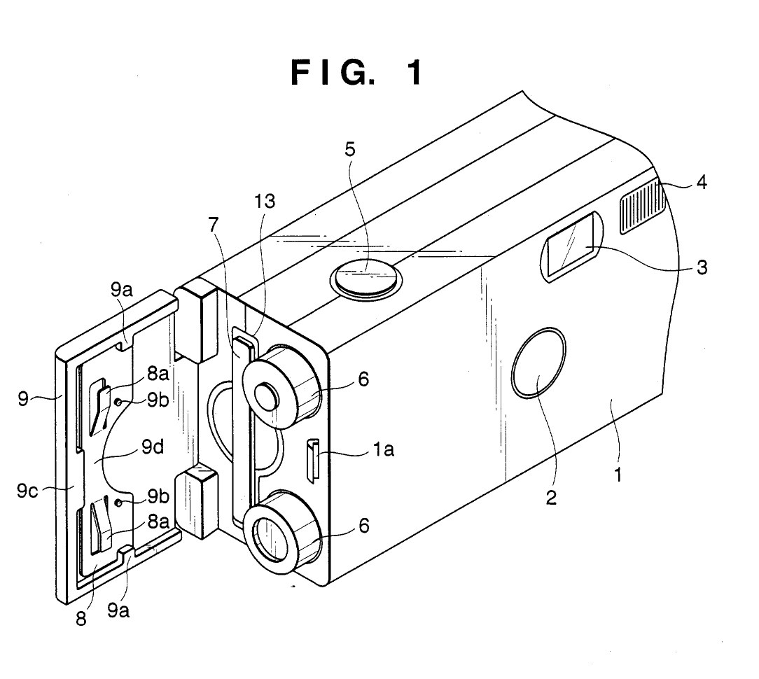

The first embodiment will be described in detail with reference to FIGS. 1 to 5.

Referring to FIGS. 1 to 5, reference numeral 1 denotes an image sensing device main body 1. An opening 2 for the photographing lens of a photographing optical system is arranged on the front surface of the image sensing device main body 1. This optical system forms an object image on an image sensing element.

A flash light emission window 4 which emits light as required when, e.g., the light quantity is not sufficient during photographing is formed at the upper right of FIGS. 1 to 3. A liquid crystal display unit (not shown) is formed on the rear surface of the image sensing device main body 1, and is used to check the object image to be sensed and to reproduce and display the sensed image.

Reference numeral 5 denotes a shutter release button. When the shutter release button 5 is operated, the object image is sensed, so the image data of the object image is recorded on a recording medium 7 (to be described later).

Reference numerals 6 denote main batteries (including rechargeable batteries in addition to one-way batteries) serving as a power supply. Reference numeral 7 denotes a recording medium to be removably housed in a recording medium housing chamber 13. The signal-processed object image is recorded on the recording medium 7. The recording medium 7 can be inserted in and removed from the image sensing device main body 1. Reference numeral 9 denotes a battery lid which can open and close battery housing chambers 12. When the battery lid 9 is opened, the openings of the battery housing chambers 12 and recording medium housing chamber 13 are open, so that the main batteries 6 and recording medium 7 can be inserted or removed.

The battery lid 9 has an engaging portion 9c at its closed position where the respective openings are closed, so as to keep the openings closed. The engaging portion 9c is caught by a locking portion 1a formed on the apparatus, and is locked by it.

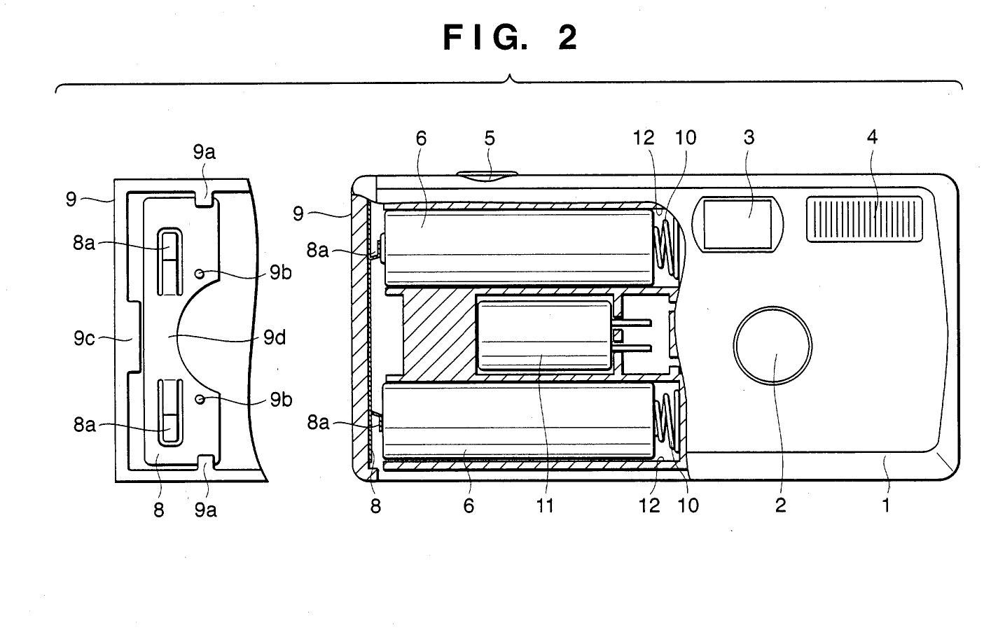

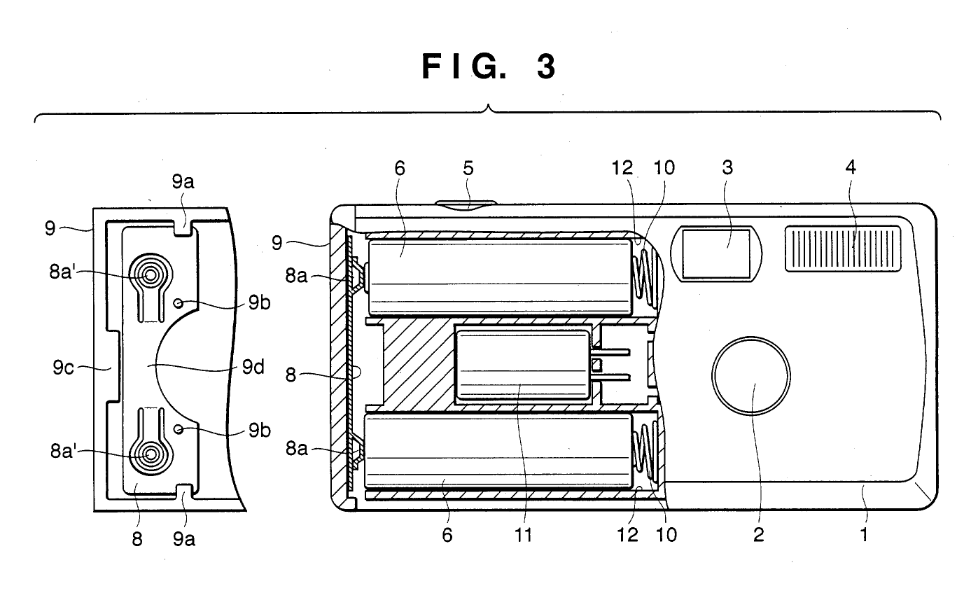

Reference numeral 8 denotes an electrode plate formed of a conductive member, in which a spring pressure/spring fore (elastic force) is imparted to battery contact portions 8a. The electrode plate 8 is elastically mounted and engaged by electrode plate engaging portions 9a and 9b (the electrode plate engaging portions 9b also serve as positioning members for the purpose of incorporating batteries) and the elastic force of the electrode plate 8. Reference numerals 10 denote coil spring-like battery contact pieces on the deep sides in the battery housing chambers 12. Reference numeral 11 denotes a flash charging capacitor for causing the flash device to emit light (see FIGS. 2 and 3).

The electrode plate 8 is held on the inner surface of the battery lid 9 when the battery lid 9 is closed, so that it comes into contact with the electrodes of the main batteries 6.

The electrode plate 8 has the contact portions 8a which extend integrally from a flat plate-like base 9d held by the battery lid 9 so that they come into contact with the electrodes of the main batteries 6. The electrode plate 8 is formed of such an elastic body that it resists the pressing force applied by the electrodes of the main batteries 6 when the battery lid 9 is closed with the batteries 6 being housed in the battery housing chambers 12.

The contact portions 8a of the electrode plate 8 are formed of leaf spring-like members which elastically deform when the battery lid 9 is closed with the main batteries 6 being housed in the battery housing chambers 12. The reaction of the contact portions 8a is accepted by the inner surface of the battery lid 9 through the base 9d. The contact portions 8a have spring shapes which bias the battery lid 9 to push it out in the opening direction.

Of those electrode pieces of the contact portions 8a which come into contact with the electrodes of the main batteries 6 and the electrode pieces 10 which are formed in the battery housing chambers 12 and come into contact with the electrodes of the batteries opposite to the contact portions 8a, the electrode pieces around which a surrounding structure has a lower rigidity are set to have a lower elastic force.

The electrode plate 8 has such a shape that it also reinforces the battery lid 9. The electrode plate 8 can engage with the electrode plate engaging portions (holding portions) 9a and 9b, formed at the predetermined positions of the battery lid 9, by utilizing its elastic force.

The arrangement of the main part of the electronic image sensing device as an example of the electronic device of this embodiment and its layout will be described with reference to FIGS. 1 to 5.

Referring to FIG. 1, the image sensing device main body 1 has a substantially flat outer shape, and its battery lid 9 is open.

The plurality of (two in FIG. 1) main batteries 6 and the recording medium 7 are housed in the image sensing device main body 1. The main batteries 6 are separate from the electrode plate 8. The battery lid 9 is made of an insulating plastic material, and the electrode plate 8 is mounted by the electrode plate engaging portions 9a and 9b (the electrode plate engaging portions 9b also serve for positioning for incorporating) and the elastic force of the electrode plate 8. The electrode plate 8 constituted by a conductive member forms a flat portion which reinforces the battery contact portions 8a, formed by cutting and raising, and the battery lid 9.

FIG. 2 includes a partially cutaway front view of the image sensing device according to the embodiment of the present invention, and a view showing an arrangement inside the battery lid 9 of the same, in which the battery lid 9 is closed. In the battery housing chambers 12, the two circular conical coil springs 10 formed by conductive members having a spring pressure/spring force are fixed as electrode pieces to those portions which come into contact with the electrodes of the batteries opposite to the contact portions 8a.

The electrode plate 8 is formed of the flat plate-like base 9d which reinforces the battery contact portions 8a, formed by cutting and raising, and the battery lid 9. At this time, the spring pressure of the battery contact portions 8a is set to be equal to or less than the spring pressure of the coil spring contact pieces 10 which are formed at the deep side in the battery housing chambers 12. The electrode plate 8 serves to electrically connect the respective electrodes (the positive electrode of one battery and the negative electrode of the other battery) of the main batteries 6 housed in the battery housing chambers 12, so that the main batteries 6 are connected in series with each other. The electrode plate 8 also serves to produce a contact pressure, in the same manner as the coil springs 10 at the deep sides in the battery housing chambers 12 do, by the spring pressure of the battery contact portions 8a. The electrode plate 8 has an outer shape almost identical to that of the battery lid 9 so that it can engage with the battery lid 9. Thus, the electrode plate 8 also serves as a reinforcing member which reinforces the battery lid 9 such that it will not flex by the spring contact pressure.

FIG. 3 includes a partially cutaway front view showing other examples of the electrode plate and battery contact portions, and a view showing an arrangement inside the battery lid of the same.

As shown in FIG. 3, the image sensing device of FIG. 3 has almost the same arrangement as that of FIG. 2 except that the shapes of the battery contact portions 8a of the electrode plate 8 are different. With holes formed at the centers of battery contact portions 8a′ of the electrode plate 8, the friction between projections such as flashes around the holes and the battery electrodes of the main batteries 6 can ensure more reliable contact.

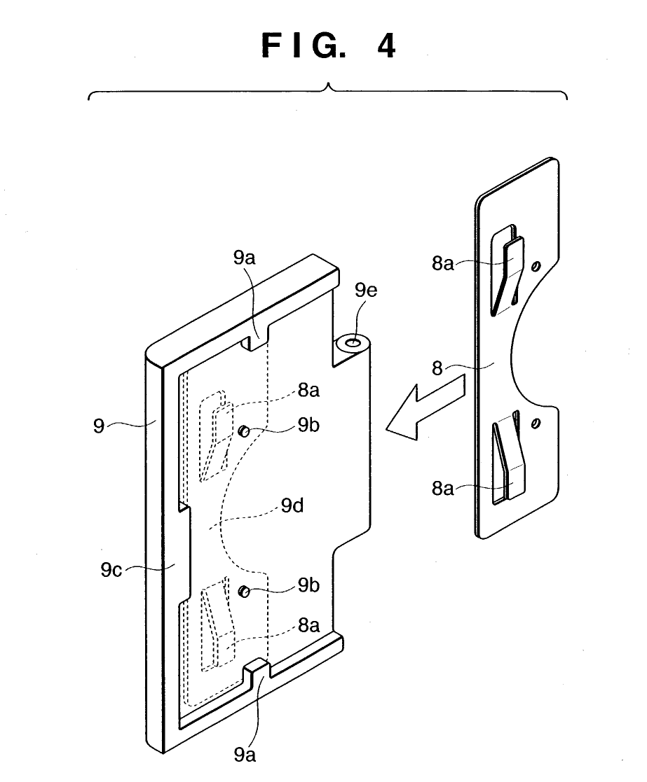

FIG. 4 is an enlarged perspective view showing in detail an assembly example of a battery lid and electrode plate.

As shown in FIG. 4, the electrode plate 8 is assembled from the direction of a hinge 9e of the battery lid 9, and is mounted by the electrode plate engaging portions 9a and 9b and the elastic force of the electrode plate 8.

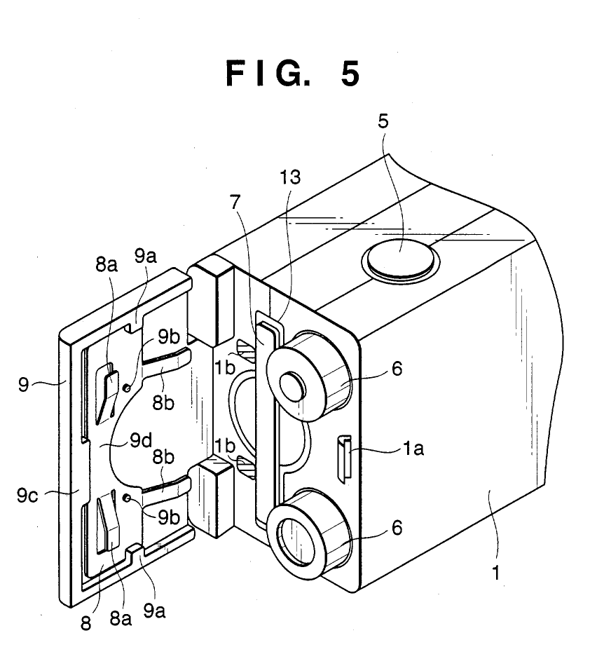

FIG. 5 is a perspective view showing in detail an arrangement with the battery lid being open, in which electrode plates/spring shape portions (spring shape portions for aiding the battery lid to open) are added. In FIG. 5, the battery lid 9 is open. The plurality of (two in FIG. 5) main batteries 6 and the recording medium 7 are housed in the image sensing device main body 1. The main batteries 6 are separate from the electrode plate 8.

The electrode plate 8 has, in addition to the battery contact portions 8a and the base 9d which reinforces the battery lid 9, electrode plates/spring shape portions (spring shape portions for aiding the battery lid to open) 8b integrally, which project and extend to oppose the edges of the openings of the battery housing chambers 12. The electrode plates/spring shape portions 8b abut against opening edge hatched portions 1b of the recording medium housing chamber 13 when the battery lid 9 is closed. When the locking mechanism of the battery lid 9 in the closed state is unlocked, the battery lid 9 opens automatically to a semi-open position by the elastic restoring force of the electrode plates/spring shape portions 8b which have elastically deformed, regardless of whether the batteries are housed or not. When the semi-opened battery lid 9 is opened fully, the main batteries 6 can be loaded in the battery housing chambers 12.

The present invention can naturally be widely applied to various types of electronic devices that use batteries or rechargeable batteries.

The shapes and the like of the electrode plates/battery contact portions 8a and 8a′ mentioned in this embodiment are not particularly limited as far as they can ensure a predetermined function.

According to the above embodiment, when the battery contact portions of an electrode plate formed of a conductive member and serving also to reinforce the battery lid are imparted with a spring pressure/spring force (elastic force) and are formed by integral molding, contact can be maintained to follow the vibration and impact of the power supply battery, and battery floating can be prevented reliably. Thus, cost reduction by means of reduction in number of components and improvement in assembling easiness can be achieved simultaneously without impairing the function the image sensing device originally has.

When batteries are to be housed, the battery contact portions of the electrode plate are elastically deformed, so that their spring pressure is accepted by the battery lid. Thus, the deforming amount of the springs can be regulated, and the springs are prevented from losing their spring properties, so that power can be supplied stably.

Of the electrode pieces of the electrode plate and the electrode pieces arranged on the deep sides in the battery housing chambers, those electrode pieces around which the surrounding structure has a low rigidity are set to have a low electrode spring pressure. Thus, the electrode springs with a higher rigidity are prevented from losing their spring properties. This can cope with a non-anticipated impact or the like and provides a good balance, so that battery floating can be prevented.

The electrode plates/spring shape portions (spring shape portions for aiding the battery lid to open) which bias the battery lid to push it up toward the open position are formed on the electrode plate formed of the conductive member, such that they project and extend to oppose the edges of the openings of the battery housing chambers. The electrode plates/spring shape portions are formed integrally with the electrode plate by integral molding. Thus, the operability of opening/closing the battery lid can be simplified without increasing the number of components. In this manner, the above embodiment has various effects.

[Second Embodiment]

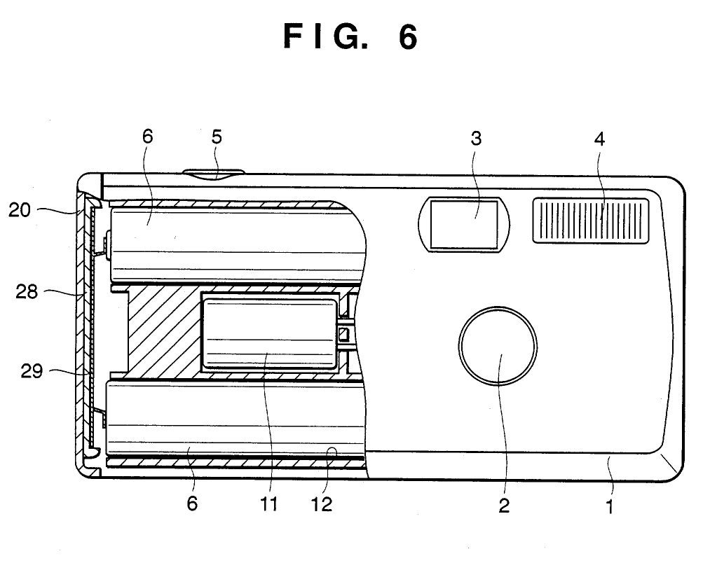

The second embodiment will be described in detail with reference to FIGS. 6 to 9. In the following description, portions that are identical to those of the first embodiment are denoted by the same reference numerals, and a detailed description thereof will be omitted.

Referring to FIGS. 6 to 9, reference numeral 20 denotes a recording medium lid for a recording medium housing chamber 13. When the recording medium lid 20 is opened and a battery lid 28 is opened, main batteries 6 can be inserted or removed. Reference numeral 29 denotes an electrode plate formed of a conductive member. When the electrode plate 29 abuts against and comes into contact with the main batteries 6, power is supplied to the respective portions of an electronic image sensing device. Reference numeral 22 denotes a hinge. The recording medium lid 20 and battery lid 28 are rotatably, axially supported about the common hinge 22 as the center, so they can be opened and closed. Reference numeral 23 denotes a strap.

Battery housing chambers 12 and the recording medium housing chamber 13 are disposed close to each other, and form a double-lid structure with the battery lid 28 as the inner lid and the recording medium lid 20 as the outer lid. When the battery lid 28 and recording medium lid 20 are closed, the inner lid and outer lid abut against each other.

The rigidity of the recording medium lid 20 is set higher than that of the battery lid 28. The battery lid 28 abuts against the recording medium lid 20 with its maximum size tolerance.

The electrode plate 29 is held on the inner surface of the battery lid 28 when the battery lid 28 is closed, so that it comes into contact with the electrodes of the main batteries 6.

The electrode plate 29 has contact portions 29a which extend integrally from a flat plate-like base 29d held by the battery lid 28 so that they come into contact with the electrodes of the main batteries 6. The electrode plate 29 is formed of such an elastic body that it resists the pressing force applied by the electrodes of the main batteries 6 when the battery lid 28 is closed with the batteries being housed in the battery housing chambers 12.

The contact portions 29a of the electrode plate 29 are formed of leaf spring-like members which elastically deform when the battery lid 28 is closed with the main batteries 6 being housed in the battery housing chambers 12. The reaction of the contact portions 29a is accepted by the inner surface of the battery lid 28 through the base 29d. The contact portions 29a have spring shapes which bias the battery lid 28 to push it out in the opening direction.

Of those electrode pieces of the contact portions 29a which come into contact with the electrodes of the main batteries 6 and electrode pieces which are formed in the battery housing chambers 12 and come into contact with the electrodes of the batteries opposite to the contact portions 29a, the electrode pieces around which a surrounding structure has a lower rigidity are set to have a low elastic force.

The electrode plate 29 has such a shape that it also reinforces the battery lid 28. The electrode plate 29 can engage with electrode plate engaging portions (holding portions) 28b, formed at the predetermined positions of the battery lid 28, by utilizing its elastic force.

The layout of the members constituting the electronic image sensing device according to this embodiment will be described with reference to FIGS. 6 to 9.

FIG. 6 is a schematic front view of the electronic image sensing device according to the embodiment of the present invention, in which both the battery lid 28 and recording medium lid 20 are closed. The plurality of (two in FIG. 6) are housed in the electronic image sensing device. The electrodes of the respective main batteries 6 (the positive electrode of one battery and the negative electrode of the other battery) and the electrode plate 29 formed of a conductive member are in contact with and electrically connected to each other, so that power is supplied to the respective portions of the electronic image sensing device. The battery lid 28 and recording medium lid 20 are made of an insulating plastic material or the like. The recording medium lid 20 has a larger thickness and higher rigidity than those of the battery lid 28 serving as the inner lid. When both the battery lid 28 and recording medium lid 20 are closed, the recording medium lid 20 abuts against the battery lid 28 to press it, thus reinforcing it.

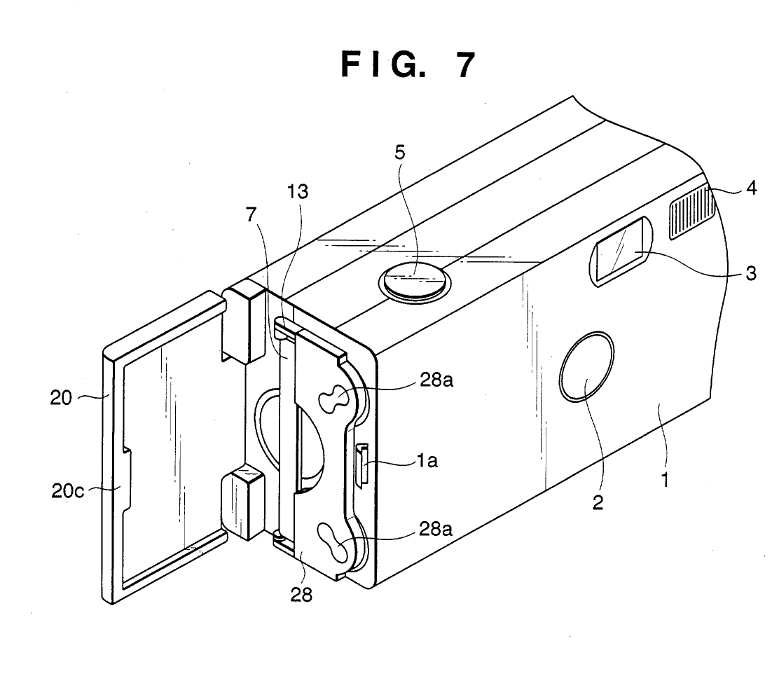

FIG. 7 is a schematic front perspective view of the electronic image sensing device according to the embodiment of the present invention, in which the recording medium lid 20 and battery lid 28 are open and closed, respectively.

The recording medium lid 20 has an engaging portion 20c at its position where it closes the openings of battery housing chambers 12 and a recording medium housing chamber 13, so as to keep the openings closed. The engaging portion 20c is caught and locked by a locking portion 1a formed on the apparatus.

When the recording medium lid 20 is open, the battery lid 28 remains closed in the same manner as the recording medium lid 20, due to a locking mechanism (not shown) which operates at the closed position. The recording medium housing chamber 13 houses a recording medium 7, and the battery housing chambers 12 house the plurality of (not shown) main batteries 6. At this time, only the recording medium 7 can be inserted and removed. Substantially gourd-shaped projections 28a are formed on the outer surface of the battery lid 28, and abut against the inner surface of the recording medium lid 20 when the recording medium lid 20 is closed.

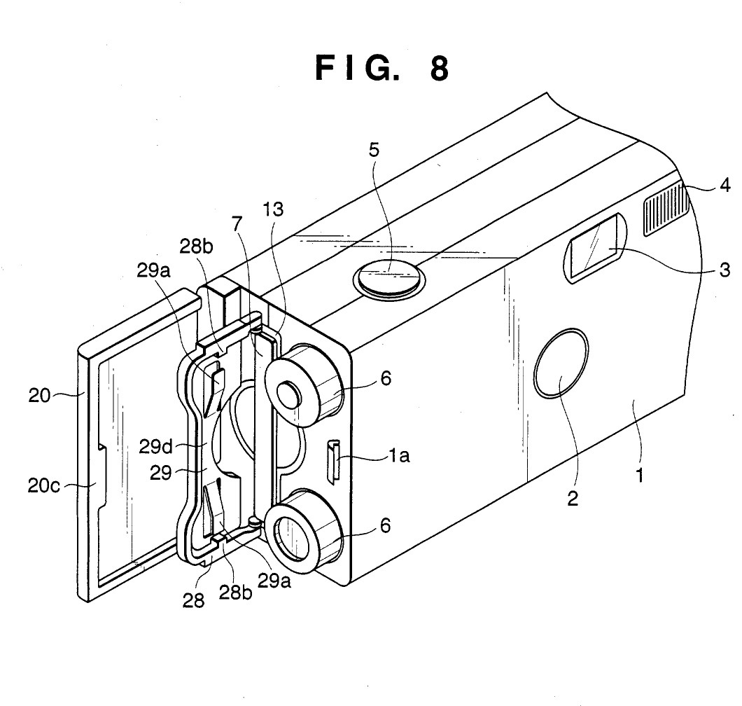

FIG. 8 is a schematic front perspective view of the electronic image sensing device according to the embodiment of the present invention, in which both the battery lid 28 and recording medium lid 20 are open. In this state, both the recording medium 7 and main batteries 6 can be inserted and removed. The main batteries 6 are biased by the elastic force of electrode pieces (not shown), arranged on the deep sides in the battery housing chambers 12, in an ejecting direction.

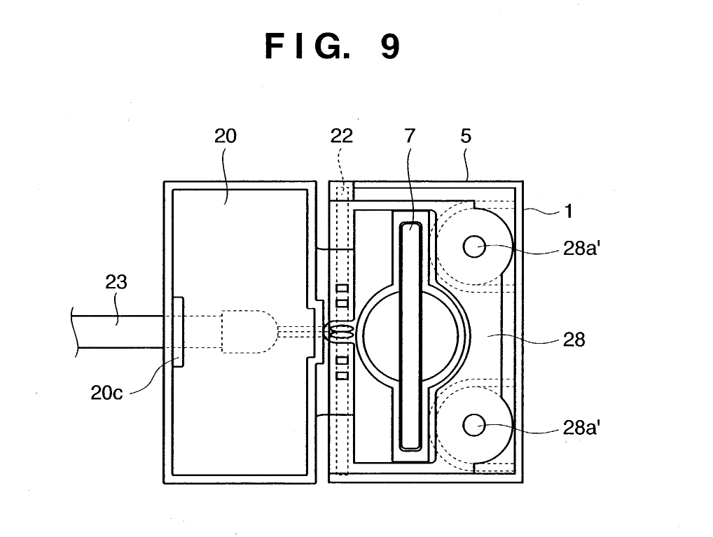

FIG. 9 is a schematic side view of the electronic image sensing device according to the embodiment of the present invention, in which the recording medium lid 20 and battery lid 28 are open and closed, respectively. In this case, only the recording medium 7 can be inserted and removed. Substantially circular projections 28a′ are formed on the battery lid 28, and abut against the inner surface of the recording medium lid 20 when the recording medium lid 20 is closed. The recording medium lid 20 and battery lid 28 share the hinge (pivot shaft) 22. The strap 23 is attached to the hinge 22.

The hinge 22 used as the attaching portion of the strap 23 need not be shared by the battery lid 28 and recording medium lid 20.

The double-lid structure according to the present invention is not limited to the electronic image sensing device of these embodiments but can naturally be widely applied to any electronic devices that use a battery and recording medium.

The projections formed on the upper surface of the battery lid 28 are exemplified by gourd-shaped ones 28a and circular ones 28a′, but their shapes are not particularly specified as far as they function well.

According to the above embodiments, a double-lid structure with the battery lid serving as the inner lid and the recording medium lid serving as the outer lid is employed. When the respective lid members are closed, the inner lid and outer lid abut against each other. Therefore, the outer appearance space required by the lid members can be minimized to achieve down sizing. The number of components can be reduced and the operation of changing the recording medium can be facilitated without impairing the function the image sensing device originally has.

As the projections on the upper surface of the battery lid abut against the recording medium lid, they do so with a minimum size. Therefore, size management is facilitated, and the abutment positioning precision can be improved.

The rigidity of the recording medium lid is set to be higher than that of the battery lid. Thus, when the battery lid is designed thin due to the requirement of the arrangement in the electronic device, even if it accepts the pressing force (spring pressure) of the battery contact pieces on the deep sides in the battery housing chambers through the batteries, it can be retained so as not to flex by the high-rigidity recording medium lid that abuts against it.

When the recording medium lid and battery lid are set such that they abut against each other with the maximum size tolerance by considering variations in size, no excessive push-up force acts on the recording medium lid.

As the battery lid and recording medium lid share the pivot shaft, the assembling workability is improved. Also, the electronic device main body can be down-sized by the reduction in number of the pivot shafts.

As the hinge (or shaft) which axially supports the battery lid or recording medium lid to be openable/closeable is used as the strap attaching shaft, no strap attaching member need be provided separately. Thus, the number of components can be reduced, and the electronic device main body can be down-sized.

The present invention is not limited to the above embodiments and various changes and modifications can be made within the spirit and scope of the present invention. Therefore, to apprise the public of the scope of the present invention, the following claims are made.

What is claimed is:

1. An electronic device comprising:
a battery lid which is openably/closeably formed at an opening of a battery housing chamber where a battery is to be loaded removably and which has an engaging portion formed at a position thereof where said battery lid closes the opening, the engaging portion being adapted to keep the opening closed; and
an electrode plate formed of a conductive member held by said battery lid so as to be in contact with an electrode of the battery when said battery lid is the closed state, wherein
said electrode plate has a contact portion extending integrally from a base thereof which is held by said battery lid so as to come into contact with the electrode of the battery, and is made of an elastic body that resists a pressing force applied by the electrode of the battery when said battery lid is closed with the battery being housed in said battery housing chamber.

2. The device according to claim 1, wherein said contact portion of said electrode plate is formed of a spring member which deforms elastically when said battery lid is closed with the battery being housed in said battery housing chamber, and a reaction force of said contact portion is accepted by said battery lid through said base.

3. The device according to claim 1, wherein of that electrode piece of said contact portion which comes into contact with the electrode of the battery and an electrode piece which is formed in said battery housing chamber and comes into contact with an electrode of the battery opposite to said contact portion, the electrode piece around which a surrounding structure has a lower rigidity is set to have a low elastic force.

4. The device according to claim 1, wherein said electrode plate has such a shape as to also reinforce said battery lid.

5. The device according to claim 1, wherein said electrode plate is supported by an inner surface of said battery lid.

6. The device according to claim 1, wherein said electrode plate can engage with a holding portion formed at a predetermined position of said battery lid by utilizing an elastic force of said electrode plate.

7. The device according to claim 1, wherein said contact portion of said electrode plate has a spring shape which biases said battery lid to be pushed out in an opening direction.

8. The device according to claim 1, further comprising a recording medium housing chamber which removably houses the recording medium, said battery housing chamber and said recording medium housing chamber are disposed close to each other, and said battery lid also has a function of opening/closing an opening of said recording medium housing chamber.

9. The device according to claim 1, further comprising a recording medium housing chamber which removably houses the recording medium and a recording medium lid which can open/close an opening of said recording medium housing chamber, said battery housing chamber and said recording medium housing chamber are disposed close to each other, said battery lid and said recording medium lid serve as an outer lid and inner lid, respectively, that form a double-lid structure, and when said respective lids are closed, said inner lid and outer lid abut against each other.

10. The device according to claim 9, wherein a projection is formed on an outer surface of said battery lid, and abuts against an inner surface of said recording medium lid.

11. The device according to claim 9, wherein said recording medium lid is set to have a higher rigidity than that of said battery lid.

12. The device according to claim 9, wherein said battery lid abuts against said recording medium lid with a maximum size tolerance thereof.

13. The device according to claim 9, wherein a hinge which axially supports said battery lid and said recording medium lid openably/closeably is shared.

14. The device according to claim 13, wherein said hinge serves as an attaching shaft for a strap.

15. The device according to claim 1, wherein a plurality of batteries or rechargeable batteries are removably loaded in said battery housing chamber.

16. An apparatus comprising:
a recording medium housing chamber for housing a recording medium;
a battery housing chamber for housing a battery;
a first lid for opening/closing said recording medium housing chamber; and
a second lid for opening/closing said battery housing chamber, said second lid being formed inside said first lid.

17. The apparatus according to claim 16, wherein said first and second lids abut against each other when closed.

18. The apparatus according to claim 17, wherein said second lid has a projection against which said first lid abuts.

19. The apparatus according to claim 16, wherein said first lid has a rigidity higher than that of said second lid.

20. The apparatus according to claim 16, wherein said second lid abuts against said first lid with a maximum size tolerance thereof.

21. The apparatus according to claim 16, further comprising a common hinge for axially supporting said first and second lids to be openable/closeable.

22. The apparatus according to claim 20, wherein said common hinge is formed such that a strap can be attached thereto.

23. The apparatus according to claim 16, further comprising a hinge which axially supports said first and second lids to be openable/closeable and to which a strap can be attached.

24. The apparatus according to claim 16, wherein said battery housing chamber can house a plurality of batteries.

25. The apparatus according to claim 16, wherein said apparatus comprises an image sensing device.

26. The apparatus according to claim 25, wherein image-sensed image data is stored on the recording medium which is to be housed in said recording medium housing chamber.
